(19) United States
(12) Patent Application Publication
(10) Pub. No.: US 2025/0214121 A1
(43) Pub. Date: Jul. 3, 2025

(54) METHOD FOR CLEANING THE SURFACE OF A BAR MATERIAL, CLEANING STATION AND SCREW MANUFACTURING PLANT WITH SUCH A CLEANING STATION

(71) Applicant: SLCR-Lasertechnik GmbH, Düren (DE)

(72) Inventor: Olav G. SCHULZ-GAUS, Bergheim (DE)

(21) Appl. No.: 19/000,919

(22) Filed: Dec. 24, 2024

(30) Foreign Application Priority Data
Dec. 29, 2023 (DE) 102023136881.8

(51) Int. Cl. B08B 7/00; B08B 9/023

(52) U.S. Cl. CPC B08B 7/0042; B08B 9/023

(57) ABSTRACT

The present invention relates to a method for cleaning the surface of a metallic rod material (2) extending in a longitudinal direction, in which the rod material (2) is moved in the longitudinal direction through a cleaning station (1), characterized in that in the cleaning station (1) at least one laser beam (9) is directed onto the surface of the rod material (2) to be cleaned, which laser beam (9) removes impurities present on the surface. The invention also relates to a cleaning station (1) and a screw manufacturing plant (12).

### RELATED APPLICATIONS AND CLAIM TO PRIORITY

This application is related to application number DE 10 1023 136 881.8, filed Dec. 29, 2023 in Germany, the complete disclosure of which is incorporated herein and to which priority is claimed.

### FIELD OF THE INVENTION

The present invention relates to a method for cleaning the surface of a metallic rod material extending in a longitudinal direction, in which the rod material is moved in the longitudinal direction through a cleaning station. Furthermore, the invention relates to a cleaning station designed for carrying out such a method and to a screw manufacturing plant comprising a rod material cutting-to-length station, at least one rod material forming station and such a cleaning station.

### BACKGROUND OF THE INVENTION

Screws are manufactured from metallic rod material with a circular cross-section, which is usually cold-formed beforehand to increase its strength. Before the rod material is cut to length and the actual screw shape is subsequently formed, which is usually achieved by hot or cold forming, it is advisable to remove any impurities present on the surface of the rod material, such as black scale, oxides, oils, greases, emulsions, stearates and the like, which have remained on the surface during the production of the rod material. Various methods are used for surface cleaning, in which the surface of the rod material is cleaned in a cleaning station chemically, ultrasonically, using a high-pressure fluid, mechanically or in another form. In this context, reference is made by way of example to DE 10 2011 017 360 A1, which briefly summarizes known cleaning processes in the introductory section.

### SUMMARY OF THE INVENTION

Based on this prior art, it is an object of the present invention to provide an alternative method for the surface cleaning of a rod material extending in a longitudinal direction, in which the rod material is moved in the longitudinal direction through a cleaning station, as well as a corresponding cleaning station and a corresponding screw manufacturing plant.

To solve this object, the present invention provides a method for cleaning the surface of a metallic rod material extending in a longitudinal direction, in which the rod material is moved in the longitudinal direction through a cleaning station, characterized in that in the cleaning station at least one laser beam is directed onto the surface of the rod material to be cleaned, which laser beam removes impurities present on the surface. It has been found that the surface cleaning of rod material by means of laser radiation is very effective, as proper cleaning results are achieved even at very high movement speeds of the rod material compared to known cleaning methods. In addition, cleaning rod material using laser radiation is very environmentally friendly, as no cleaning agents or chemical substances are used. In addition, cleaning rod material using laser radiation requires significantly less space, especially compared to the chemical cleaning methods typically used, and the rod material can be processed immediately after cleaning.

According to one embodiment of the method according to the invention, at least three, preferably at least four laser beams are directed onto the surface to be cleaned, distributed over the circumference of the rod material. Depending on the diameter of the rod material, the entire circumference of the rod material can be covered with at least three such laser beams.

Advantageously, the at least one laser beam is directed onto the rod material in a direction which has a direction vector pointing against the direction of movement of the rod material. Particularly good cleaning results are achieved when the laser beam or laser beams are aligned in this way.

The angle drawn by the laser beam(s) and the rod material is preferably in the range of 70 to 90°.

Preferably, removed impurities are evacuated.

According to one embodiment of the present invention, the degree of contamination of the rod material is detected before cleaning and the parameters of the laser irradiation are controlled as a function of the detected degree of contamination. In this way, an optimum cleaning result can be achieved.

The cleaning result is preferably recorded for quality control and/or for readjusting the parameters of the laser irradiation.

According to one embodiment of the present invention, the method is carried out as a machining step of a screw manufacturing process, in particular before forming and subsequent cutting to length of the rod material.

Furthermore, the present invention provides a cleaning station with a laser irradiation device, characterized in that it is designed to carry out a method according to the invention.

According to one embodiment of the present invention, the laser irradiation device has a processing chamber with a rod material inlet and a rod material outlet, at least one laser optic being positioned inside the processing chamber, preferably several laser optics are positioned inside the processing chamber, which can be aligned in such a way that it/they can apply laser radiation to the entire circumference of a rod material moved through the processing chamber in the longitudinal direction of the rod material. In this way, a simple design is achieved that can be easily adapted to different wire geometries.

The at least one laser optic or the several laser optics can preferably be moved in such a way that at least the distance and angle of the laser beam or laser beams emitted by it/them to the rod material moving through the processing chamber can be changed.

Both pulsed and continuously emitting laser sources can be used as laser sources. The wavelength can vary depending on the material and/or the dimensions of the rod material and/or the type of contamination to be removed.

Optionally, the laser irradiation device can have a sensor device and a control system which are designed and set up in such a way that the sensor device detects the degree of contamination before cleaning and the control system regulates at least one parameter of the laser irradiation as a function of the detected degree of contamination.

Preferably, the laser irradiation device has a sensor device and a control unit which are designed and set up in such a way that the sensor device detects the cleaning result, whereby the detected cleaning result is used for quality control and/or for readjusting the parameters of the laser irradiation.

Advantageously, the laser processing device has an evacuation device to properly remove the ablated material from the processing site.

In addition, the present invention provides a screw manufacturing plant comprising a rod material forming and cutting-to-length station, wherein the screw manufacturing plant has a cleaning station according to the present invention, which is arranged ahead, preferably immediately ahead, the rod material forming and cutting-to-length station.

### BRIEF DESCRIPTION OF THE FIGURES

Further features and advantages of the present invention will become clear from the following description with reference to the accompanying drawing. Therein

FIG. 1 is a schematic side view of a cleaning station according to one embodiment of the present invention;

FIG. 2 is a schematic view along line II-II in FIG. 1;

FIG. 3 is a schematic view showing the orientation of a laser beam emitted from a laser optics of the cleaning station shown in FIG. 1; and

FIG. 4 is a schematic view of a screw manufacturing plant.

### DETAILED DESCRIPTION OF THE PREFERRED EMBODIMENT(S)

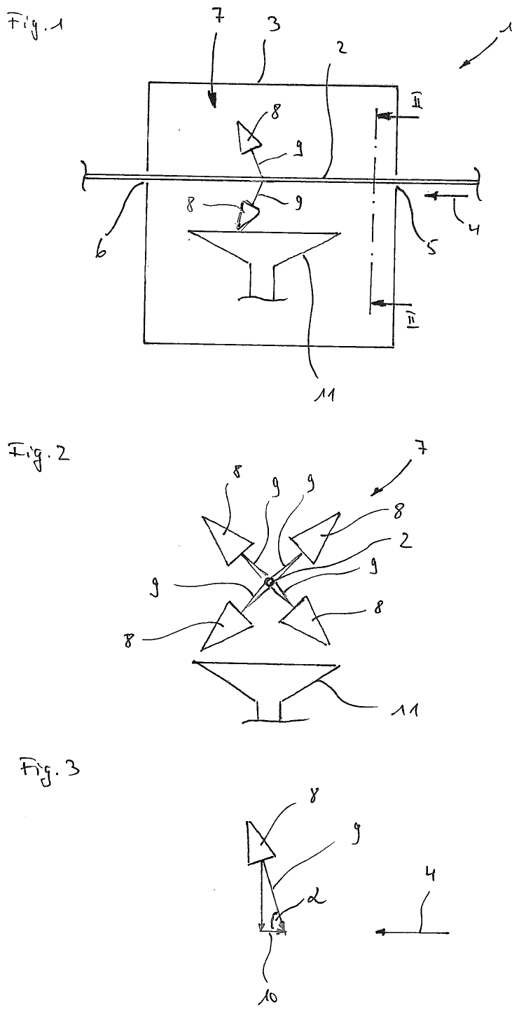

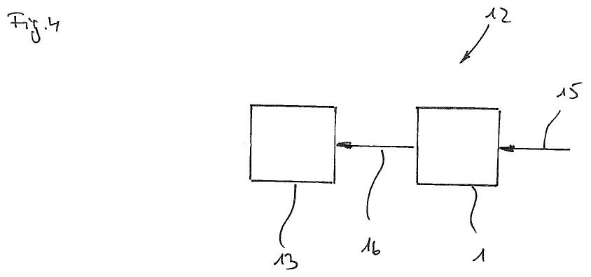

FIG. 1 shows a cleaning station 1 according to one embodiment of the present invention, which is used to clean the surface of a rod material 2 extending in a longitudinal direction and having a circular cross-section in the present case. In principle, the rod material 2 can have any diameter used in the manufacture of screws. The cleaning station 1 comprises a processing chamber 3, through which the rod material 2 is moved in the direction of the arrow 4 from a rod material inlet 5 to a rod material outlet 6 of the processing chamber 3. A laser irradiation device 7 is arranged inside the processing chamber 3, which has several laser optics 8, in the present case four laser optics 8. Each of the laser optics 8 can be moved in such a way that at least the distance and angle of the laser beams 9 emitted by them to the rod material 2 moving through the processing chamber 3 can be changed. In the embodiment shown, the laser optics 8 are orientated in such a way that the laser beams 9 emitted by them completely cover the circumference of the rod material 2 within a processing location. The laser beams 9 can partially overlap each other at the processing location. Advantageously, the laser beams 9 are each directed onto the rod material 2 in a direction which, as shown in FIG. 3, has a direction vector 10 pointing in the opposite direction to the direction of movement 4 of the rod material 2. The angle α that the laser beams 9 and the rod material 2 enclose is preferably in the range of 70 to 90°. Furthermore, the processing chamber 3 comprises an evacuation device 11, which is designed to extract the impurities removed from the surface of the rod material 2 by means of laser radiation.

Both pulsed and continuously emitting laser sources can be used as laser sources. The wavelength can vary depending on the material and/or the dimensions of the rod material and/or the type of contamination to be removed.

Optionally, the laser irradiation device 7 can have a sensor device 14 and a controller 17, which are designed and set up in such a way that the sensor device 14 detects the degree of contamination before cleaning and the controller 17 regulates at least one parameter of the laser irradiation depending on the detected degree of contamination. Alternatively or additionally, the sensor device 14 and the control unit 17 can be designed and set up in such a way that the sensor device 14 detects the cleaning result, whereby the detected cleaning result is used for quality control and/or for readjusting the parameters of the laser irradiation. For this purpose, the sensor device 14 can, for example, be equipped with one or more cameras which are directed at the surface of the rod material in front of and/or behind the processing location. Based on the image data, the surface quality of the rod material is then evaluated, in particular in real time, using image recognition software.

During operation of the cleaning station 1, the rod material 2 is continuously moved in the direction of the arrow 4 through the processing chamber 3 and cleaned using the laser irradiation device 7.

FIG. 4 schematically shows a screw manufacturing plant 12 comprising a cleaning station 1 according to the invention and a rod material forming and cutting-to-length station 13, whereby the latter can also be subdivided into several individual stations. The rod material 2 to be cleaned is first fed to the cleaning station 1 in the direction of the arrow 15. The surface-cleaned rod material 2 then leaves the cleaning station 1 in the direction of the arrow 16 and is then fed to the rod material forming and cutting-to-length station 13. In this station, the bar stock 2 is given the desired shape and cut to length by means of hot or cold forming. Alternatively or additionally, the rod material forming and cutting-to-length station 13 can also have a threading device.

Finally, it should be noted that the embodiments described above serve only as examples and are not to be understood as limiting. Rather, changes and/or modifications are possible without departing from the scope of protection defined by the appended claims.

1. Method for cleaning the surface of a metallic rod material (2) extending in a longitudinal direction, in which the rod material (2) is moved in the longitudinal direction through a cleaning station (1), comprising the cleaning station (1) has at least one laser beam (9) directed onto the surface of the rod material (2) to be cleaned, which laser beam (9) removes impurities present on the surface.

2. The method for cleaning the surface of a metallic rod material (2) according to claim 1, wherein the cleaning station (1) at least three, preferably at least four laser beams (9) are directed onto the surface to be cleaned, distributed over the circumference of the rod material (2).

3. The method for cleaning the surface of a metallic rod material (2) according to claim 1, wherein the at least one laser beam (9) is directed onto the rod material (2) in a direction which has a direction vector (10) pointing against the direction of movement of the rod material (2).

4. The method for cleaning the surface of a metallic rod material (2) according to claim 1, wherein the angle (α) drawn by the laser beam or beams (9) and the rod material (2) is in the range from 70 to 90.

5. The method for cleaning the surface of a metallic rod material (2) according to claim 1, wherein removed impurities are evacuated.

6. The method for cleaning the surface of a metallic rod material (2) according to claim 1, wherein the degree of contamination of the rod material (2) is detected before cleaning and the parameters of the laser irradiation are controlled as a function of the detected degree of contamination.

7. The method for cleaning the surface of a metallic rod material (2) according to claim 1, wherein the cleaning result is recorded for quality control and/or for readjusting the parameters of the laser irradiation.

8. The method for cleaning the surface of a metallic rod material (2) according to claim 1, wherein it is carried out as a machining step of a screw manufacturing process.

9. The method for cleaning the surface of a metallic rod material (2) according to claim 8, wherein this is carried out before the rod material (2) is cut to length.

10. Cleaning station (1) with a laser irradiation device (7), wherein it is designed to carry out a method according to claim 1.

11. The cleaning station (1) according to claim 10, wherein the laser irradiation device (7) has a processing chamber (3) with a rod material inlet (5) and a rod material outlet (6), at least one laser optic (8) being positioned inside the processing chamber (3), preferably several laser optics (8) are positioned inside the processing chamber (3), which can be aligned in such a way that it/they can apply laser radiation to the entire circumference of a rod material (2) moved through the processing chamber (3) in the longitudinal direction of the rod material.

12. The cleaning station (1) according to claim 11, wherein the at least one laser optic or the several laser optics (8) can be moved in such a way that at least the distance and angle of the laser beam or laser beams (9) emitted by it/them to the rod material (2) moving through the processing chamber (3) can be changed.

13. The cleaning station (1) according to claim 10, wherein the laser irradiation device (7) has an evacuation device (11).

14. The cleaning station (1) according to claim 10, wherein the laser irradiation device (7) has a sensor device (14) and a controller (17), which are designed and set up in such a way that the sensor device (14) detects the degree of contamination before cleaning and the controller (17) regulates at least one parameter of the laser irradiation as a function of the detected degree of contamination.

15. The cleaning station (1) according to claim 10, wherein the laser irradiation device (7) has a sensor device (14) and a controller (17) which are designed and set up in such a way that the sensor device (14) detects the cleaning result, the detected cleaning result being used for quality control and/or for readjusting the parameters of the laser irradiation.

16. Screw manufacturing plant (12) comprising a rod material forming and cutting-to-length station (13), wherein the screw manufacturing plant (12) has a cleaning station (1) according to claim 10, which is arranged ahead, preferably immediately ahead, the rod material forming and cutting-to-length station (13).

17. The method for cleaning the surface of a metallic rod material (2) according to claim 2, wherein the at least one laser beam (9) is directed onto the rod material (2) in a direction which has a direction vector (10) pointing against the direction of movement of the rod material (2).

18. The method for cleaning the surface of a metallic rod material (2) according to claim 2, wherein the angle (α) drawn by the laser beam or beams (9) and the rod material (2) is in the range from 70 to 90.

19. The method for cleaning the surface of a metallic rod material (2) according to claim 3, wherein the angle (α) drawn by the laser beam or beams (9) and the rod material (2) is in the range from 70 to 90.

20. The method for cleaning the surface of a metallic rod material (2) according to claim 2, wherein removed impurities are evacuated.
